(19) United States
(12) Patent Application Publication
(10) Pub. No.: US 2025/0187348 A1
(43) Pub. Date: Jun. 12, 2025

(54) APPARATUS, METHOD, AND STORAGE MEDIUM

(71) Applicant: CANON KABUSHIKI KAISHA, Tokyo (JP)

(72) Inventor: TETSUYA HAMADA, Kanagawa (JP)

(21) Appl. No.: 18/957,516

(22) Filed: Nov. 22, 2024

(30) Foreign Application Priority Data
Dec. 6, 2023 (JP) 2023-206405

(51) Int. Cl. B41J 3/32; B41J 11/00; B41M 3/16; G06K 15/00; G06K 15/10; G09B 21/02

(52) U.S. Cl. CPC B41J 3/32; B41J 11/0022; B41M 3/16; G06K 15/102; G06K 15/4065; G09B 21/02

(57) ABSTRACT

An apparatus includes at least one processor and at least one memory that is in communication with the at least one processor. The at least one memory stores instructions for causing the at least one processor and the at least one memory to acquire first information indicating a type of a recording medium, and second information indicating a predetermined standard relating to a three-dimensional shape to be formed on the recording medium, and to generate print data for forming the three-dimensional shape based on the first information and the second information.

### BACKGROUND

### Field of the Disclosure

The present disclosure relates to a technique for forming three-dimensional shapes.

### Description of the Related Art

An inkjet printer using liquid ink ejects ink to record an image, and fixes the image to a sheet recording medium. The conventional inkjet printer is used to print two-dimensional images, and its print processing parameters are set to print the two-dimensional images with high quality. In recent years, there have been inkjet printers for printing two-dimensional images that can even print convex shapes. Examples of using a technique for forming convex portions on a recording medium include a known inkjet printer using ultraviolet curable ink (hereinafter, UV ink). Japanese Patent Application Laid-Open No. 2016-206478 discusses a technique for ejecting UV ink to a recording medium and curing the UV ink through irradiation with ultraviolet rays to form convex portions.

The technique disclosed in Japanese Patent Application Laid-Open No. 2016-206478, however, involves printing with parameters and printing operations different from those of the conventional two-dimensional image printing to form certain convex portions on recording media with UV ink, which causes inconvenience.

### SUMMARY

Some embodiments of the present disclosure are directed to control of three-dimensional shapes using a method with high convenience when the three-dimensional shapes are formed on a recording medium.

According to an aspect of the present disclosure, an apparatus includes at least one processor and at least one memory that is in communication with the at least one processor. The at least one memory stores instructions for causing the at least one processor and the at least one memory to acquire first information indicating a type of a recording medium, and second information indicating a predetermined standard relating to a three-dimensional shape to be formed on the recording medium, and to generate print data for forming the three-dimensional shape based on the first information and the second information.

Further features of various embodiments will become apparent from the following description of exemplary embodiments with reference to the attached drawings.

### BRIEF DESCRIPTION OF THE DRAWINGS

FIG. 1 is a diagram illustrating a configuration example of an image forming apparatus according to a first exemplary embodiment.

FIG. 2 is a block diagram illustrating the hardware configuration of the image forming apparatus according to the first exemplary embodiment.

FIG. 3 is a diagram illustrating a configuration example of an image forming system according to the first exemplary embodiment.

FIG. 4 is a diagram illustrating a display example of a print job setting screen according to the first exemplary embodiment.

FIGS. 5A and 5B are diagrams illustrating structures of characters for visually impaired persons according to the first exemplary embodiment.

FIG. 6 is a table illustrating an example of standards of characters for visually impaired persons according to the first exemplary embodiment.

FIG. 7 is a block diagram illustrating a procedure of image processing according to the first exemplary embodiment.

FIG. 8 is a diagram illustrating foaming promotion ink according to the first exemplary embodiment.

FIG. 9 is a diagram illustrating a relationship between the amount of foaming promotion ink applied and the height of the convex shape according to the first exemplary embodiment.

FIG. 10 is a diagram illustrating a method for determining the amount of foaming promotion ink applied from the height of a raised dot in a standard of characters for visually impaired persons according to the first exemplary embodiment.

FIGS. 11A to 11D are diagrams each illustrating a relationship between the amount of foaming promotion ink applied and the height of the convex shape according to the first exemplary embodiment.

FIG. 12 is a diagram illustrating an example of a lookup table (LUT) for the height of the convex shape according to the first exemplary embodiment.

FIG. 13 is a flowchart illustrating a procedure of image forming processing according to the first exemplary embodiment.

FIG. 14 is a diagram illustrating a display example of a screen for selecting a specification of characters for visually impaired persons according to the first exemplary embodiment.

FIGS. 15A and 15B are diagrams each illustrating an arrangement example of ink dots constituting a raised dot according to a second exemplary embodiment.

FIGS. 16A and 16B are diagrams illustrating a method for correcting the diameter of a print dot according to the second exemplary embodiment.

FIG. 17 is a block diagram illustrating a procedure of image processing according to the second exemplary embodiment.

FIG. 18 is a diagram illustrating the diameter of a flat part according to a third exemplary embodiment.

FIGS. 19A and 19B are diagrams illustrating a method for controlling the diameter of the flat part according to the third exemplary embodiment.

FIGS. 20A and 20B are diagrams each illustrating an arrangement example of ink dots constituting a raised dot according to the third exemplary embodiment.

### DESCRIPTION OF THE EMBODIMENTS

Some exemplary embodiments according to the present disclosure will now be described with reference to the drawings. The following exemplary embodiments do not limit every embodiment according to the claims, and not all of the combinations of features described in the exemplary embodiments are used for solving means of every embodiment.

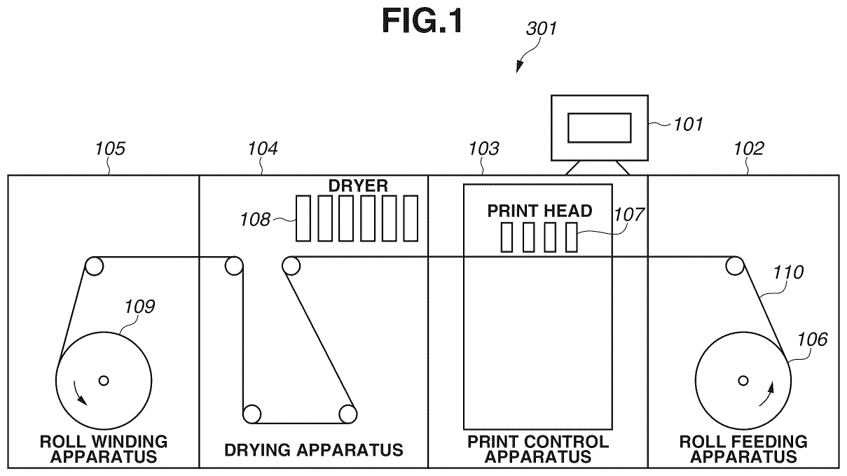

A first exemplary embodiment will be described. FIG. 1 illustrates a configuration example of an image forming apparatus according to the present exemplary embodiment. An image forming apparatus 301 includes an operation panel 101, a roll feeding apparatus 102, a print control apparatus 103, a drying apparatus 104, and a roll winding apparatus 105. The roll feeding apparatus 102 includes a feeding unit 106 around which unprinted recording medium 110 is wound in a roll shape. The roll feeding apparatus 102 pulls the recording medium 110 from the feeding unit 106. The print control apparatus 103 includes a print head 107 for ejecting ink. The print control apparatus 103 performs printing on the recording medium 110 fed from the roll feeding apparatus 102 with the print head 107. The drying apparatus 104 includes dryers 108 applying heat and wind. The drying apparatus 104 uses the dryers 108 to dry the printed recording medium 110 (the printed document). The roll winding apparatus 105 includes a winding unit 109 around which the printed document is wound in a roll shape. The roll winding apparatus 105 winds the dried printed document around the winding unit 109.

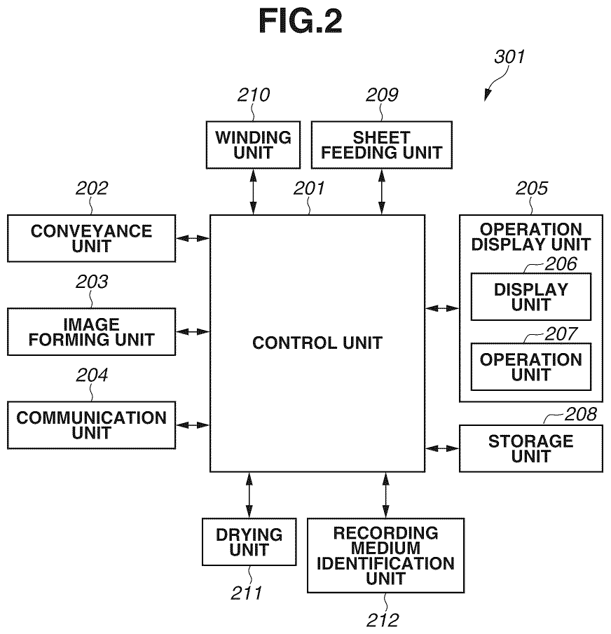

FIG. 2 is a block diagram illustrating the hardware configuration of the image forming apparatus according to the present exemplary embodiment.

The image forming apparatus 301 includes a control unit 201, a conveyance unit 202, an image forming unit 203, a communication unit 204, an operation display unit 205, a storage unit 208, a sheet feeding unit 209, a winding unit 210, a drying unit 211, and a recording medium identification unit 212. The image forming apparatus 301 is an inkjet printer.

The control unit 201 includes a central processing unit (CPU) and a random access memory (RAM). The control unit 201 generally controls the image forming apparatus 301. The CPU of the control unit 201 reads various kinds of programs, such as a system program and a processing program stored in the storage unit 208, and loads the various kinds of programs into the RAM. When the CPU of the control unit 201 runs the programs loaded into the RAM, image forming processing is performed based on a user instruction.

The conveyance unit 202 conveys the recording medium 110. The conveyance unit 202 includes a plurality of conveyance rollers, and conveys the recording medium 110 fed from the roll feeding apparatus 102 via the print control apparatus 103 and the drying apparatus 104 to the roll winding apparatus 105.

The image forming unit 203 controls the print control apparatus 103 to form an image on the recording medium 110 based on the print data.

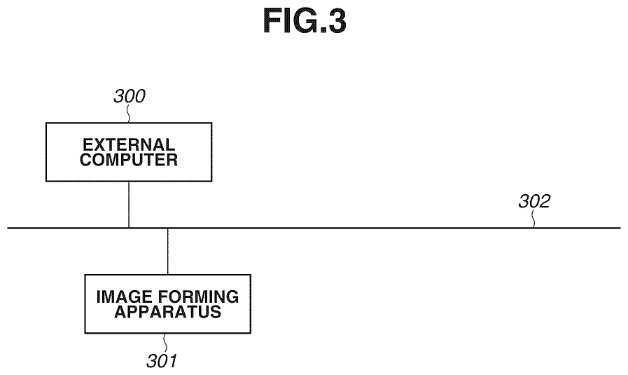

The communication unit 204 includes a communication control device, such as a local area network (LAN) card. The communication unit 204 transmits/receives various kinds of data with an external device (e.g., an external computer 300 illustrated in FIG. 3) connected to a network (e.g., a communication network 302 illustrated in FIG. 3), such as a LAN and a wide area network (WAN).

The operation display unit 205 includes a display unit 206 and an operation unit 207. The operation display unit 205 is the operation panel 101, which includes, for example, a liquid crystal display (LCD) provided with a touch panel. The display unit 206 displays various kinds of information based on display control signals input from the control unit 201. The operation unit 207 includes input devices, such as a touch panel, a keyboard, and a mouse, receives various kinds of operation input by a user, and outputs operation signals to the control unit 201.

The storage unit 208 includes a volatile semiconductor memory (so-called a flash memory) and a hard disk drive (HDD). The storage unit 208 stores various kinds of programs, such as the system program and the processing program to be executed by the control unit 201, and data for execution of the programs.

The sheet feeding unit 209 controls the roll feeding apparatus 102 to feed the recording medium 110 wound in a roll shape to print with the print control apparatus 103.

The winding unit 210 controls the roll winding apparatus 105 to wind the recording medium 110 in a roll shape printed by the print control apparatus 103 and dried by the drying apparatus 104. The wound recording medium 110 in a roll shape facilitates management and delivery of printed products.

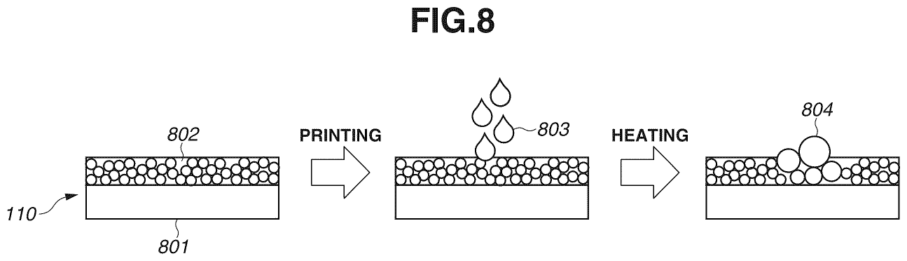

The drying unit 211 controls the drying apparatus 104. The drying unit 211 controls the dryers 108 that blow high-temperature air, and a heater that heats up to high temperature including a heat generator. The ink in the area printed by the print control apparatus 103 is not sufficiently dried. Thus, when the roll winding apparatus 105 winds the recording medium 110, the undried ink is retransferred to the recording medium 110. To prevent this, it is suitable that the ink is sufficiently dried. The drying unit 211 controls the temperature and the volume of air applied to the printed document based on the characteristics of the recording medium and the ink. A too-high set temperature can deform the recording medium 110, whereas a too-low set temperature does not dry the printed surface sufficiently. In the present exemplary embodiment, a foaming layer is provided on the surface of the recording medium 110. Thus, the drying apparatus 104 heats a recording medium printed with foaming promotion ink to form a three-dimensional shape in the area printed with the foaming promotion ink. The details will be described below with reference to FIG. 8. The height of the three-dimensional shape varies depending on the amount of foaming promotion ink applied and the amount of heat applied. Under a condition with the amount of heat applied constant, the height of the formed three-dimensional shape can be controlled based on the amount of foaming promotion ink applied.

The recording medium identification unit 212 identifies the type of the recording medium 110 set in the image forming apparatus 301. The recording medium identification unit 212 includes a sensor for measuring characteristics of the recording medium. When the recording medium 110 is set in the image forming apparatus 301, the recording medium identification unit 212 identifies the type of the recording medium 110 from the sensor value. The recording medium identification unit 212 can identify the type of the recording medium 110 with, for example, a user operation of selecting a recording medium from a pulldown menu where types of recording medium are selectable on a setting screen in the operation panel 101. Depending on the type of the recording medium 110, the height of the three-dimensional shape to the amount of foaming promotion ink applied varies.

The image forming apparatus 301 identifies the type of the recording medium 110 using the recording medium identification unit 212, and determines the amount of foaming promotion ink to be applied for a printing from the relationship between the amount of foaming promotion ink applied and the height of the convex shape on the recording medium 110.

FIG. 3 illustrates a configuration example of an image forming system according to the present exemplary embodiment. As illustrated in FIG. 3, the image forming system includes the external computer 300 and the image forming apparatus 301. The external computer 300 and the image forming apparatus 301 are connected to each other through a communication network 302, and mutually transmit/receive various kinds of data. In FIG. 3, one external computer 300 and one image forming apparatus 301 are provided, but a plurality of external computers and a plurality of image forming apparatuses can be included.

In response to a user instruction, the external computer 300 generates image data, and transmits a print job including the generated image data, print settings, and the setting of the number of prints, to the image forming apparatus 301 through the communication network 302. The control unit 201 of the image forming apparatus 301 receives the data about the print job transmitted from the external computer 300 through the communication unit 204. The control unit 201 of the image forming apparatus 301 stores the received data about the print job in the storage unit 208.

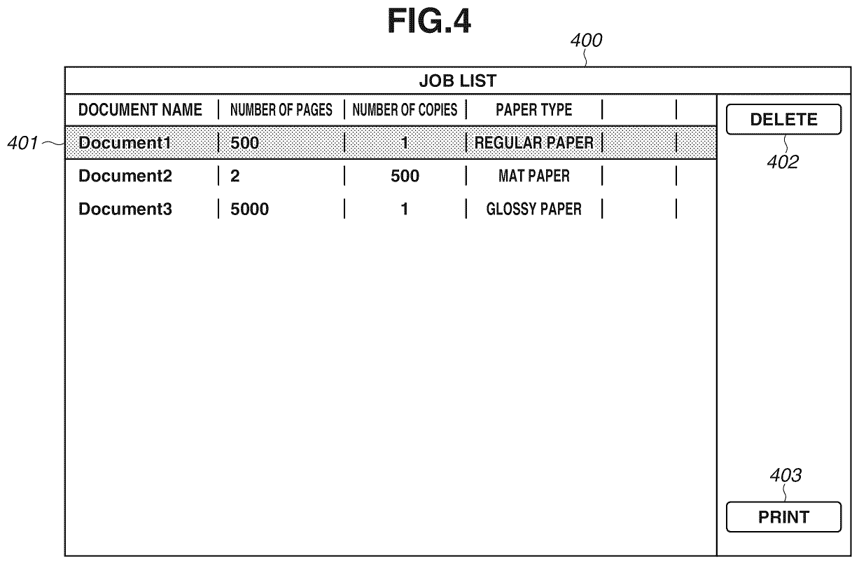

FIG. 4 is a diagram illustrating an example of a print job setting screen. A setting screen 400 illustrated in FIG. 4 is displayed on the display unit 206 under the control of the control unit 201. The setting screen 400 displays a list of the pieces of data about print jobs transmitted from the external computer 300 in the transmission order. In the example illustrated in FIG. 4, data, such as a document name, the number of pages, the number of copies, and a paper type, is displayed in the list. When a user operates the operation unit 207, the print jobs displayed in the list are selectable. A display item 401 indicates a selected print job. A delete button 402 is a button for deleting the data on the selected print job from the storage unit 208.

A print button 403 is a button for starting a printing of the selected print job.

In the present exemplary embodiment, a method for performing printing with foaming promotion ink on a recording medium to form raised dots of characters having convex portions for visually impaired persons. The characters are used for visually impaired persons to read and write.

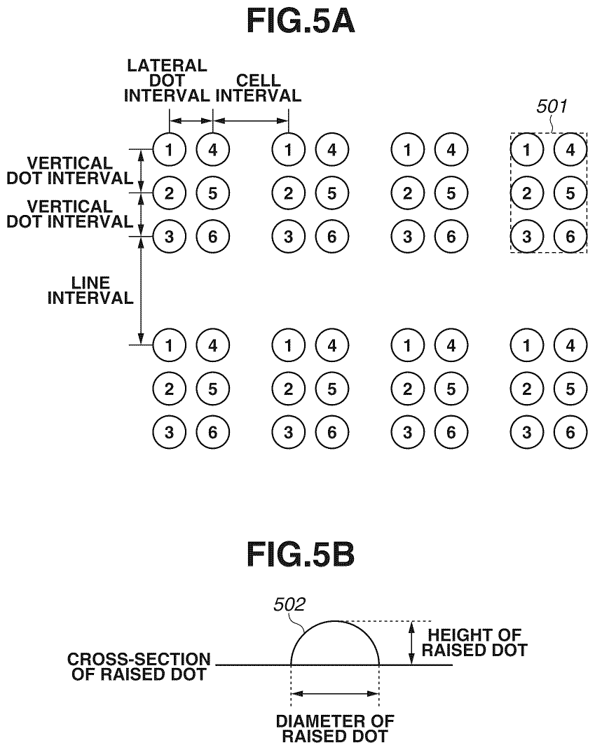

FIG. 5A illustrates an arrangement of characters for visually impaired persons. As illustrated in FIG. 5A, one character for visually impaired persons is represented by six raised dots arranged in three rows and two columns in one cell 501. The interval between two raised dots laterally arranged in one cell is referred to as a lateral dot interval, and the interval between two raised dots vertically arranged in one cell is referred to as a vertical dot interval. The lateral interval between cells is referred to as a cell interval, and the vertical interval between cells is referred to as a line interval. FIG. 5B illustrates the cross-sectional shape of a raised dot 502. The height of the raised dot 502 is referred to as the height of a raised dot, and the diameter of the raised dot 502 is referred to as the diameter of a raised dot. The values of the lateral dot interval, the vertical dot interval, the cell interval, the line interval, the diameter of the raised dot, and the height of the raised dot illustrated in FIGS. 5A and 5B are standardized by country and region of the world, and printing is performed complying with standards of the characters for visually impaired persons.

Formation of convex portions of characters for visually impaired persons is an example of formation of the three-dimensional shapes. In the present exemplary embodiment, an example will be described where the convex shapes of characters for visually impaired persons are formed based on a standard of characters for visually impaired persons.

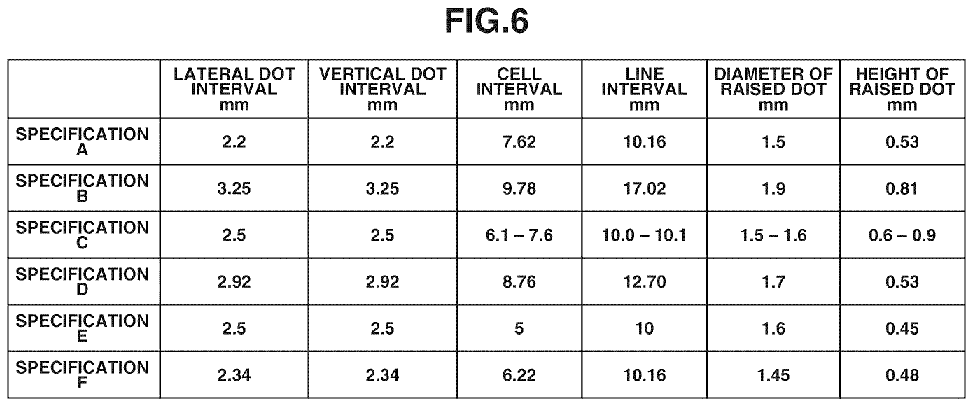

FIG. 6 illustrates standards of the characters for visually impaired persons. The standards of the characters for visually impaired persons define the values of the lateral dot interval, the vertical dot interval, the cell interval, the line interval, the diameter of the raised dot, and the height of the raised dot depending on the country and the region in the world as illustrated in specifications A to F in FIG. 6. Examples of standards of the characters for visually impaired persons include Japanese Industrial Standards (JIS) and Braille. The standards of the characters for visually impaired persons as illustrated in specifications A to F in FIG. 6 are databased and stored in the storage unit 208. The standards of the characters for visually impaired persons are examples of standard information for three-dimensional printing. The standard information for three-dimensional printing is not limited to the standards of the characters for visually impaired persons, and is not particularly limited as long as the standard relates to three-dimensional shapes formed on recording media.

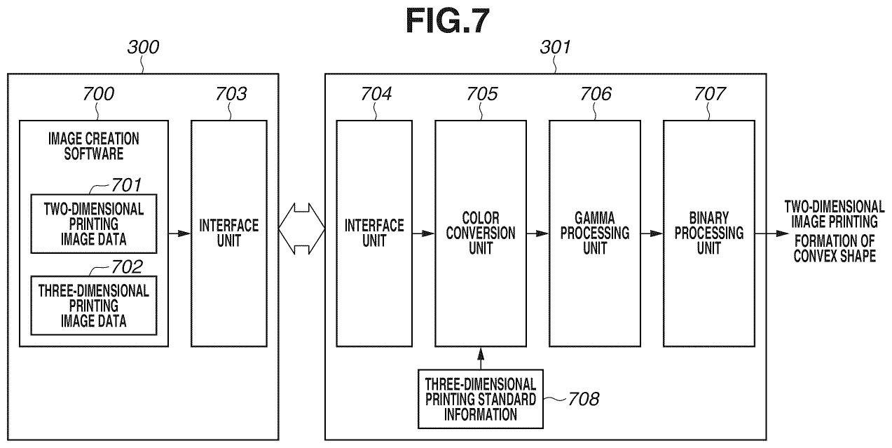

A procedure of image processing according to the present exemplary embodiment will be described with reference to FIG. 7.

Image creation software 700 is installed in the external computer 300. Two-dimensional printing image data 701 and three-dimensional printing image data 702 are generated by the image creation software 700. The two-dimensional printing image data 701 is data about a planar print image, such as a poster image, a label image, and a picture image. The three-dimensional printing image data 702 is data about a three-dimensional print image, such as the characters for visually impaired persons and convex decorative images. The generated printing image data is transmitted from an interface unit 703 of the external computer 300 through the communication network 302 to an interface unit 704 of the image forming apparatus 301. The interface unit 704 is included in the communication unit 204 of the image forming apparatus 301.

The image forming apparatus 301 includes a color conversion unit 705, a gamma processing unit 706, and a binary processing unit 707. When the control unit 201 of the image forming apparatus 301 runs programs stored in the storage unit 208, the functions of the color conversion unit 705, the gamma processing unit 706, and the binary processing unit 707 are carried out. Three-dimensional printing standard information 708 is also stored in the storage unit 208 of the image forming apparatus 301.

The color conversion unit 705 performs a color conversion processing on the printing image data received by the interface unit 704. As for the two-dimensional printing image data 701, the color conversion unit 705 performs processing for converting the signal values of colors of the pixels into print data values indicating the amounts of color inks (e.g., YMCK) to be applied used in the image forming apparatus 301. More specifically, a lookup table for target colors is used. As for the three-dimensional printing image data 702, the color conversion unit 705 reads the standard of the characters for visually impaired persons selected by a user, from the three-dimensional printing standard information 708 stored in the storage unit 208. Further, the color conversion unit 705 acquires the amount of foaming promotion ink to be applied, namely, a print data value for forming the height of raised dots defined in the selected standard of the characters for visually impaired persons, by using data about relationships between the amounts of foaming promotion ink applied and the heights of the convex shapes on individual recording media. Thereafter, the color conversion unit 705 performs processing for converting the three-dimensional printing image data 702 into the amount of foaming promotion ink to be applied, namely, the print data value for forming the height of raised dots defined in the selected standard of the characters for visually impaired persons.

The gamma processing unit 706 performs gamma processing on the two-dimensional printing image data and the three-dimensional printing image data subjected to the conversion processing by the color conversion unit 705. The binary processing unit 707 generates print data to be printed with the print head 107 from the two-dimensional printing image data and the three-dimensional printing image data subjected to the gamma processing by the gamma processing unit 706. The control unit 201 controls the image forming unit 203 to perform printing based on the generated print data. At this time, two-dimensional printing using color ink and three-dimensional printing using foaming promotion ink are simultaneously performed. In the three-dimensional printing, convex portions are formed on the recording medium 110.

A mechanism for forming the convex portions will be described with reference to FIG. 8. FIG. 8 illustrates a schematic cross-section of the recording medium 110 in an enlarged manner. The recording medium 110 includes a base material 801 and a foaming layer 802 provided on the base material 801. Foaming promotion ink 803 different in components from those of the color ink used for the two-dimensional printing is applied to the foaming layer 802, and the foaming layer 802 is expanded by heating. The foaming layer 802 contains a particulate foaming material 804. In the three-dimensional printing, the foaming promotion ink 803 is ejected from the print head 107, and permeates into the foaming layer 802. When the foaming layer 802 is heated thereafter, the foaming material 804 expands in the foaming layer 802 permeated with the foaming promotion ink 803 to form convex portions as illustrated. In the present exemplary embodiment, an example is described where foaming promotion ink is colorless and does not affect the colors of the two-dimensional image even when the foaming promotion ink is used at the same time as the two-dimensional printing using the color ink. However, the foaming promotion ink can be colored.

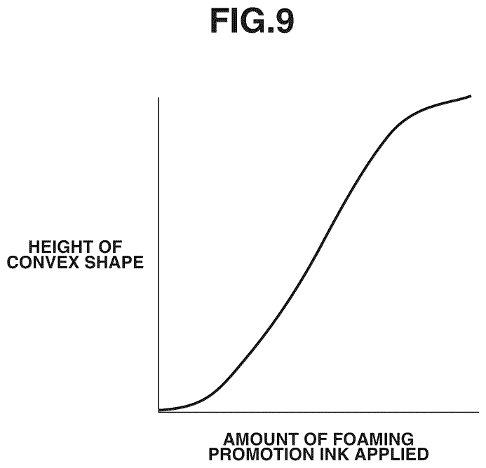

FIG. 9 is a diagram illustrating a relationship between the amount of foaming promotion ink applied and the height of the convex shape (the height of a three-dimensional shape) in a recording medium. In a graph illustrated in FIG. 9, the lateral axis indicates the amount of foaming promotion ink applied to the recording medium, and the vertical axis indicates the height of the convex shape formed on the recording medium. The shape of the illustrated curve varies depending on the condition, such as the type of recording medium and the drying time.

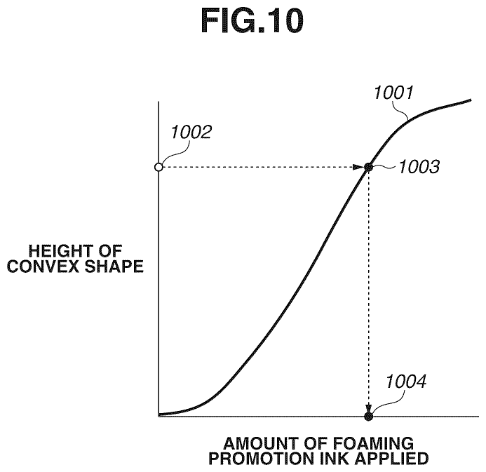

FIG. 10 is a diagram illustrating a method for determining a print data value from the graph illustrated in FIG. 9. Information about the amount of foaming promotion ink applied, namely, a print data value 1004 is read based on an intersection 1003 of a curve 1001 and a value 1002 of the height of the raised dot defined in the standard of the characters for visually impaired persons selected by the user. The shape of the curve 1001 varies depending on the recording medium and the drying condition. Thus, the print data value, namely, the amount of foaming promotion ink applied for forming the height of the raised dot defined in the standard of the characters for visually impaired persons varies when the recording medium or the drying condition is different even with the same standard of the characters for visually impaired persons selected.

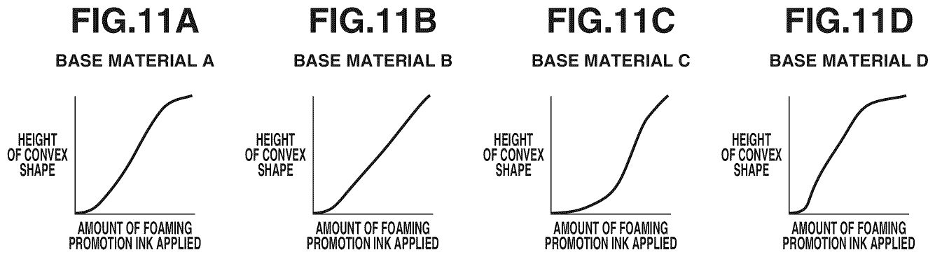

FIGS. 11A to 11D are diagrams illustrating relationships between the amounts of the foaming promotion ink applied and the heights of the convex shapes on a plurality of recording media. Graphs in FIGS. 11A to 11D are examples of relationships between the amounts of foaming promotion ink applied and the heights of the convex shapes on the recording media. FIGS. 11A to 11D illustrate relationships between the amounts of foaming promotion ink applied and the heights of the convex shapes on base materials A to D. The base materials A to D are print base materials each including a foaming layer, and are different in property (e.g., expansion coefficient) of the foaming layer from one another. In other words, reactions to amounts of foaming promotion ink applied are different between the base materials A to D. Even when the information about the amount of foaming promotion ink applied, namely, the print data value is determined from the value of the height of the raised dot defined in the standard of the characters for visually impaired persons selected by the user, the relationship between the amount of foaming promotion ink applied and the height of the convex shape is different depending on the recording medium even if the raised dot to be formed has the same height. Thus, the print data value varies depending on the type of recording medium.

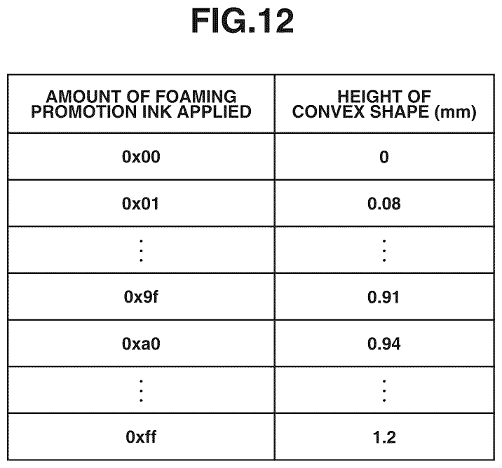

FIG. 12 illustrates a one-dimensional lookup table (hereinafter, a LUT) indicating the relationships between the amounts of foaming promotion ink applied and the heights of the convex shapes illustrated in FIG. 9. The LUT allows the determination of the amount of foaming promotion ink applied, namely, the print data value from the value of the height of the raised dot defined in the standard of the characters for visually impaired persons selected by the user. For example, when the value of the height of the raised dot is 0.94 mm in a standard of the characters for visually impaired persons, the amount of foaming promotion ink applied corresponding to a height of the convex shape of 0.94 mm is 0xa0 in hexadecimal notation. Thus, the printing with a print data value of 0xa0 can form a raised dot having a height of 0.94 mm on the recording medium. In the present exemplary embodiment, the relationships between the amounts of foaming promotion ink applied and the heights of the convex shapes on the recording media as illustrated in FIGS. 11A to 11D are stored in the storage unit 208 in an LUT format.

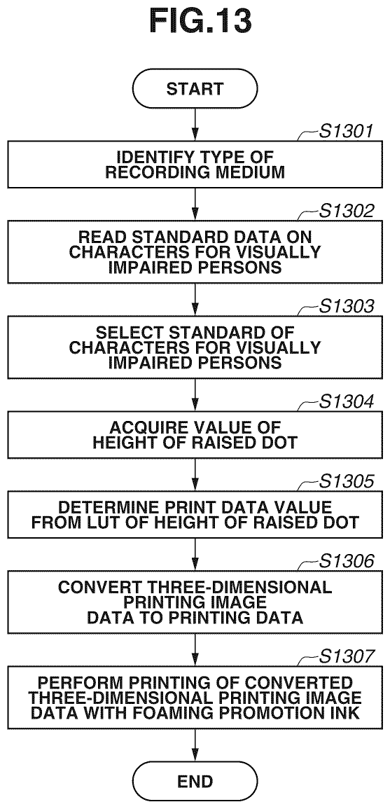

FIG. 13 is a flowchart illustrating a procedure of the image forming processing. When the control unit 201 of the image forming apparatus 301 runs programs stored in the storage unit 208, the processing in the flowchart is performed. An external computer can function as an image processing apparatus to perform the processing in the flowchart, or another image processing apparatus can perform a part of the processing in the flowchart.

The processing in the flowchart is performed when the start of the printing of a print job which includes three-dimensional printing image data is instructed.

In step S1301, the control unit 201 identifies the type of recording medium to be printed using the recording medium identification unit 212. The type of recording medium can be specified by a user, or can be determined from the sensor value by the sensor for measuring characteristics of the recording medium. The processing proceeds to step S1302.

In step S1302, the control unit 201 reads the standards of the characters for visually impaired persons (the standard data on the characters for visually impaired persons) as a database from the storage unit 208. The processing proceeds to step S1303.

In step S1303, the control unit 201 shows the standard data on the characters for visually impaired persons read in step S1302 to the user. The control unit 201 selects a standard of the characters for visually impaired persons used for three-dimensional printing in response to an operation of the operation unit 207 by the user. The processing proceeds to step S1304.

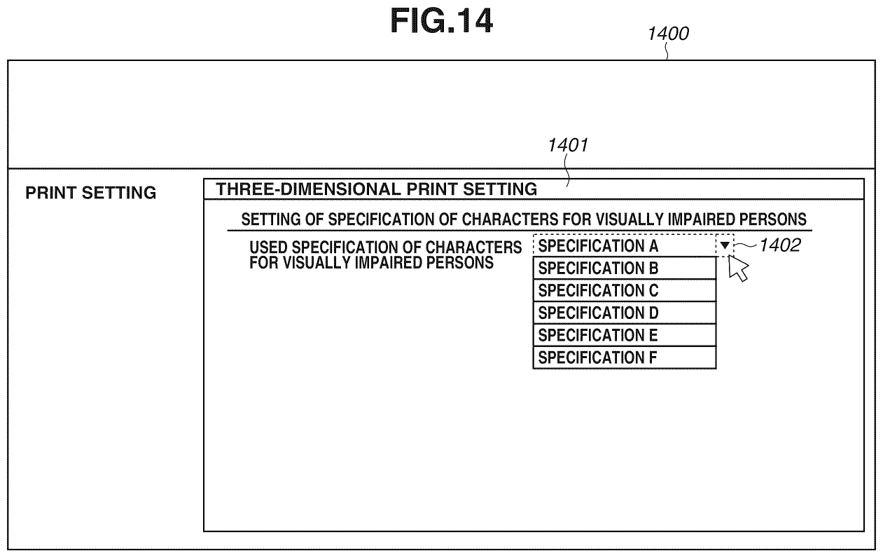

FIG. 14 illustrates an example of a user interface (UI) for selecting a standard of the characters for visually impaired persons. A UI 1400 illustrated in FIG. 14 is displayed on the display unit 206 under the control of the control unit 201. The UI 1400 includes a three-dimensional print setting 1401 for making print settings of three-dimensional printing. In the three-dimensional print setting 1401, a list of selectable specifications of the characters for visually impaired persons is displayed in a pulldown menu 1402. A user operates the operation unit 207 and selects a desired specification of the characters for visually impaired persons from the list of the specifications displayed in the pulldown menu 1402. For a user to correctly select a specification of the characters for visually impaired persons, the specifications of the characters for visually impaired persons can be sorted and displayed by country or region in the three-dimensional print setting 1401. Depending on the current location information, a part of the specifications of the characters for visually impaired persons alone can be displayed, or the display order of the specifications of the characters for visually impaired persons can be changed.

In step S1304, the control unit 201 acquires the value of the height of the raised dot to be formed from the information about the standard of the characters for visually impaired persons selected in step S1303. The processing proceeds to step S1305.

In step S1305, the control unit 201 determines the information about the amount of foaming promotion ink applied, namely, the print data value for reflecting the value of the height of the raised dot defined in the selected standard of the characters for visually impaired persons, by using the relationship between the amount of foaming promotion ink applied and the height of the convex shape on the type of recording medium identified in step S1301. In the present exemplary embodiment, the storage unit 208 stores the LUT (see FIG. 12) indicating the relationships between the amounts of foaming promotion ink applied and the heights of the convex shapes on the recording media. The control unit 201 reads the LUT corresponding to the identified type of recording medium to determine the information about the amount of foaming promotion ink applied, namely, the print data value corresponding to the value of the height of the raised dot defined in the selected standard of the characters for visually impaired persons. The control unit 201 can calculate the print data value by using data schematizing the relationship between the amount of foaming promotion ink applied and the height of the convex shape without an LUT. The processing proceeds to step S1306.

In step S1306, as for the two-dimensional printing image data, the control unit 201 performs a color matching processing such that the print result of the two-dimensional printing image data has target colors, for example, colors complying with Japan Color or International Organization for Standardization (ISO) standards. As for the three-dimensional printing image data, the control unit 201 performs processing of converting the three-dimensional printing image data into the print data value determined in step S1305. In other words, in this step, the control unit 201 performs color conversion processing for generating target colors on the two-dimensional printing image data, and performs the conversion processing for forming the height of the raised dot defined in the standard of the characters for visually impaired persons on the three-dimensional printing image data. The processing proceeds to step S1306.

In step S1307, the control unit 201 controls the image forming unit 203 to perform printing of the three-dimensional printing image data subjected to the conversion processing in step S1306 on the recording medium 110 including the foaming layer with foaming promotion ink. A figure (a circle in the case of the characters for visually impaired persons) is printed on the recording medium 110 based on the data through the conversion processing. The diameter of an ink droplet in printing is extremely small compared with that of the raised dot. Thus, the circle of the raised dot is formed with a plurality of ink droplets. After a predetermined drying step, the ink layer printed on the portions of the raised dots is transformed into the convex portions serving as the raised dots by the effect of foaming promotion ink. At the same time as printing of the raised dots (the three-dimensional printing), the printing of the two-dimensional printing image subjected to the conversion processing in step S1306 is performed using the color ink (the two-dimensional printing), and the resultant image is also dried in a drying step to generate the desired colors.

The series of processing in the flowchart then ends.

According to the above-described present exemplary embodiment, when three-dimensional image printing is performed by an image forming apparatus that performs two-dimensional image printing, the three-dimensional shape on the recording medium can be controlled based on a predetermined standard relating to the three-dimensional shape through the mechanism similar to the color conversion performed in two-dimensional printing with high image quality.

A second exemplary embodiment will now be described. In the first exemplary embodiment, the method has been described of determining the print data value focusing on the height of a raised dot defined in a standard of the characters for visually impaired persons. In the present exemplary embodiment, a method will be described of correcting and adjusting the diameter of a print dot to that of the raised dot defined in a standard of the characters for visually impaired persons. In the following, the descriptions similar to those according to the first exemplary embodiment will be omitted.

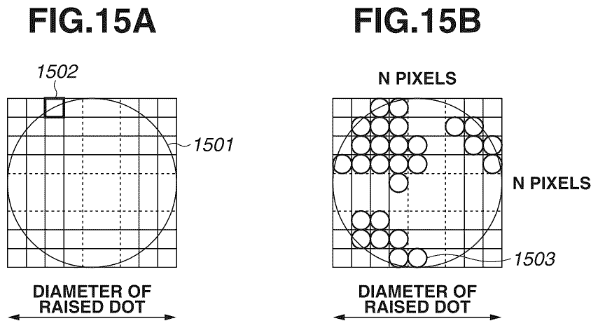

FIGS. 15A and 15B illustrate a relationship between the diameter of a raised dot and ink dots. A raised-dot bottom surface 1501 indicates the bottom surface of raised dots forming characters for visually impaired persons, and has the diameter of a raised dot defined in a standard of the characters for visually impaired persons. The raised-dot bottom surface 1501 has a circular shape. A print pixel 1502 indicates the size of one pixel printed by the image forming apparatus 301. The print pixel 1502 is determined based on a print resolution of the image forming apparatus 301. An ink dot 1503 indicates a dot formed by an ink droplet ejected from the print head 107 on the recording medium 110. The circle is formed by printing to form the ink dots 1503 at the positions of the pixels to fill the inside of the raised-dot bottom surface 1501 with the ink dots 1503. The diameter of a raised dot varies depending on the standard of the characters for visually impaired persons as illustrated in FIG. 6. The number of print pixels N is represented by the following equation (1) using a diameter D (mm) of the raised dot and a print resolution X (dpi). One inch is 25.4 mm.

N=X/25.4×D (1)

When printing is performed with typical ink, using the above-described equation (1), the ink dots 1503 are formed at the positions of the pixels forming a raised dot to fill with N pixels the inside of the circular shape corresponding to the diameter of the raised dot defined in a standard of the characters for visually impaired persons. On the other hand, the formation of the convex portions of characters for visually impaired persons with foaming promotion ink causes the ink dots 1503 to spread due to the expansion of the forming promotion ink. Thus, printing to fill the inside of a circular shape with N pixels at the positions of the pixels forming the raised dot forms a convex portion having a diameter greater than the diameter D of the raised dot defined in a standard of the characters for visually impaired persons.

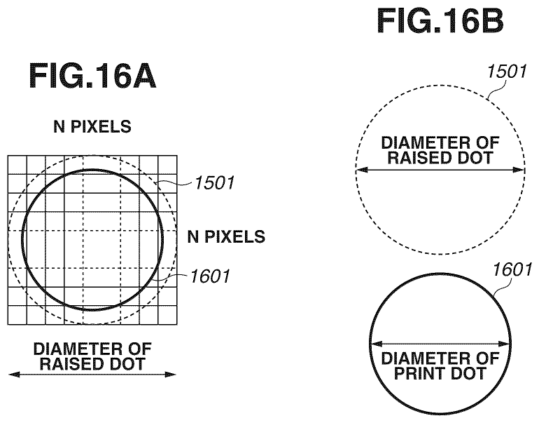

FIGS. 16A and 16B illustrate a relationship between the size of a print dot and a standard of the characters for visually impaired persons considering the expansion. To form a desired size of the raised-dot bottom surface 1501, a print dot 1601 is to be printed in a size slightly smaller than that of the raised-dot bottom surface 1501 in consideration of the expansion due to foaming promotion ink. When the diameter of the print dot 1601 is referred to as that of a print dot, the diameter of the print dot is represented by the following equation (2).

The diameter of a print dot=the diameter of a raised dot defined in a standard of the characters for visually impaired persons×correction coefficient (2)

The correction coefficient here is a value less than or equal to 1.0. The correction coefficient is a value calculated from the coefficient of expansion determined by a combination of the type of recording medium and information about the amount of foaming promotion ink to be applied to form a predetermined height of a raised dot described in the first exemplary embodiment, namely, a print data value. The correction coefficient can be previously determined based on the type of recording medium.

In FIGS. 15A and 15B, the illustrated size ratio of the ink dot to the diameter of the raised dot is greater than the actual size ratio for description. Further, the ink dots are partially omitted.

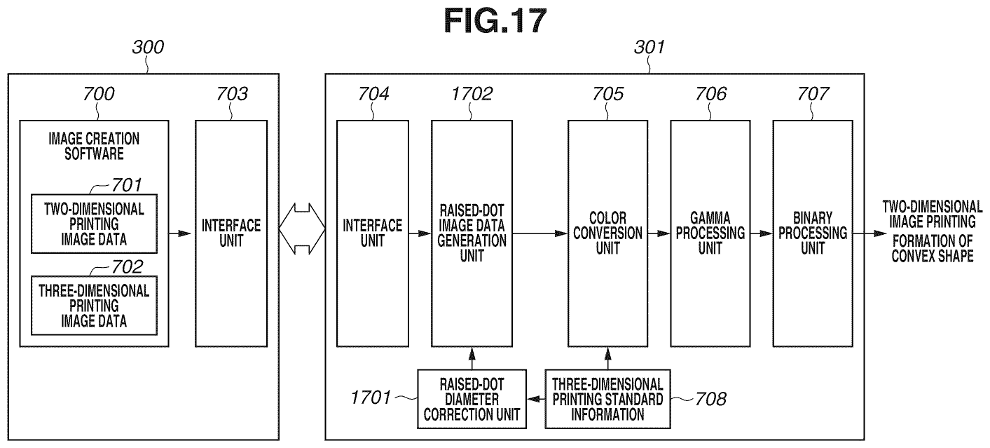

A procedure of image processing according to the present exemplary embodiment will be described with reference to FIG. 17. In the present exemplary embodiment, a step of correcting the diameter of a raised dot is added as compared with the case in the first exemplary embodiment. In the following, differences from FIG. 7 will be described. FIG. 17 is different from FIG. 7 in that the image forming apparatus 301 includes a raised-dot diameter correction unit 1701 and a raised-dot image data generation unit 1702.

The raised-dot diameter correction unit 1701 reads the standard of the characters for visually impaired persons selected by a user from the three-dimensional printing standard information 708 stored in the storage unit 208, and performs correction processing on the value of the diameter of a raised dot in the read standard of the characters for visually impaired persons. The above-described equation (2) is used to perform the correction processing.

The raised-dot image data generation unit 1702 calculates the number of pixels forming a print dot to be printed from information about the diameter of the print dot as the diameter of the raised dot corrected by the raised-dot diameter correction unit 1701 and the print resolution to generate raised-dot image data. The above-described equation (1) is used to calculate the number of pixels forming the print dot.

The color conversion unit 705 converts the raised-dot image data generated by the raised-dot image data generation unit 1702 into raised-dot image data for forming the height of the raised dot defined in the selected standard of the characters for visually impaired persons by using the relationship between the amount of foaming promotion ink applied and the height of the convex shape in the identified type of recording medium.

In the present exemplary embodiment, processing is performed similarly to the processing in the flowchart illustrated in FIG. 13. In the following, differences from the first exemplary embodiment will be described.

In step S1304, the control unit 201 acquires the height of the raised dot to be formed and the value of the diameter of the raised dot from the information about the standard of the characters for visually impaired persons selected in step S1303.

In step S1305, the control unit 201 performs the correction processing on the value of the diameter of the raised dot defined in the selected standard of the characters for visually impaired persons based on the identified type of recording medium and other information. Through the processing, the diameter of the print dot slightly smaller than that of the raised dot is calculated. The control unit 201 generates raised-dot image data from the calculated diameter of the print dot and the information about the print resolution. The control unit 201 determines the information about the amount of foaming promotion ink applied, namely, the print data value for reflecting the value of the height of the raised dot defined in the selected standard of the characters for visually impaired persons by using the relationship between the amount of foaming promotion ink applied and the height of the convex shape in the identified type of recording medium.

In step S1306, the control unit 201 converts the three-dimensional printing image data with the raised-dot image data generated in step S1305, and then converts the three-dimensional printing image data into the print data value determined in step S1305.

According to the above-described present exemplary embodiment, when characters for visually impaired persons are printed by an image forming apparatus performing two-dimensional image printing, the three dimensional shape formed on a recording medium can be controlled based on the height of the raised dot and the diameter of the raised dot defined in a standard of the characters for visually impaired persons through the mechanism similar to the color conversion performed in two-dimensional printing with high image quality.

In the second exemplary embodiment, the example has been described where the numbers of pixels in the vertical direction and in the horizontal direction forming the circular shape to be printed thereon are both set to N. However, the numbers of pixels in the vertical direction and in the horizontal direction are not necessarily equal depending on the printing method or hardware configuration.

A third exemplary embodiment will now be described. In the present exemplary embodiment, a method will be described of forming a raised dot in a shape easily identified by users of the characters for visually impaired persons. Users identify characters relying on their tactile sensation, the raised dots of which are desirably ones with facilitated identification.

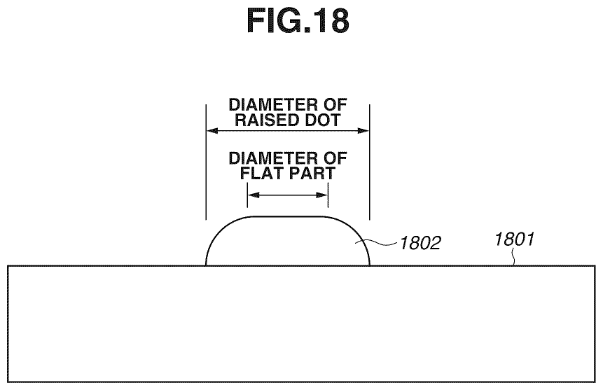

For example, users identify the characters while touching the surfaces of the raised dots, which are made of a material with slipperiness to some extent. Further, raised dots having uneven sizes or sharp apexes are not desirable. FIG. 18 illustrates the cross-sectional shape of a raised dot described in the present exemplary embodiment. In other words, FIG. 18 illustrates the cross-sectional shape in a perpendicular direction of a raised dot 1802 formed on a recording medium 1801. When the cross-sectional shape of the raised dot is a circular shape or a semidome shape, a small area of a raised dot that will be in contact with the user's skin causes the user to feel hard when touching raised dots, the character of which is not easy to identify. Thus, as illustrated, a part of the center part (the apex) of the raised dot is made flat, making it possible to increase the area touched by a finger to improve the sensation to facilitate the identification. In the following, a method will be described of making a part of the apex of the raised dot flat. In the following, the descriptions similar to the those according to the second exemplary embodiment are omitted.

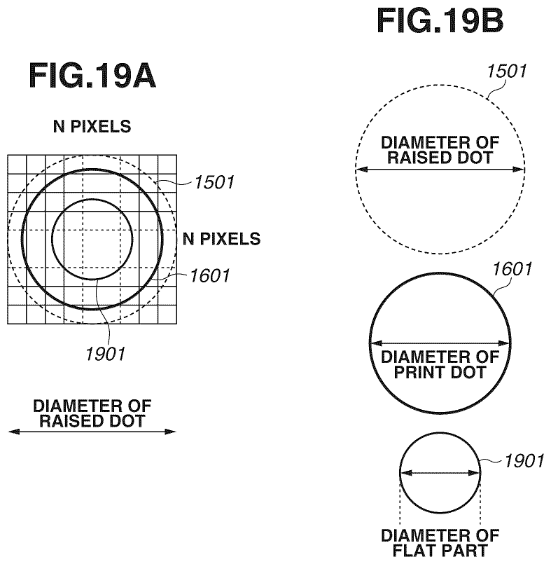

FIGS. 19A and 19B illustrate a relationship between the size of a print dot considering the expansion and the size of a flat part of the apex of the raised dot. In the present exemplary embodiment, as in the second exemplary embodiment, to form a desired size of the raised-dot bottom surface 1501, the print dot 1601 slightly smaller than the raised-dot bottom surface 1501 is printed in consideration of the expansion by foaming promotion ink. The diameter of a flat part 1901 indicates the size of the flat part of the apex of the raised dot. The diameter of the flat part 1901 is determined by, for example, the performance of the image forming apparatus 301, the type of recording medium, and the identification easiness of the characters for visually impaired persons when being actually touched with a finger. As for the diameter of the flat part 1901, an appropriate value for each recording medium can be determined based on the result of a test previously performed under various kinds of conditions in combination or based on the result calculated with parameters in combination. A method for determining the value of the diameter of a flat part is not particularly limited.

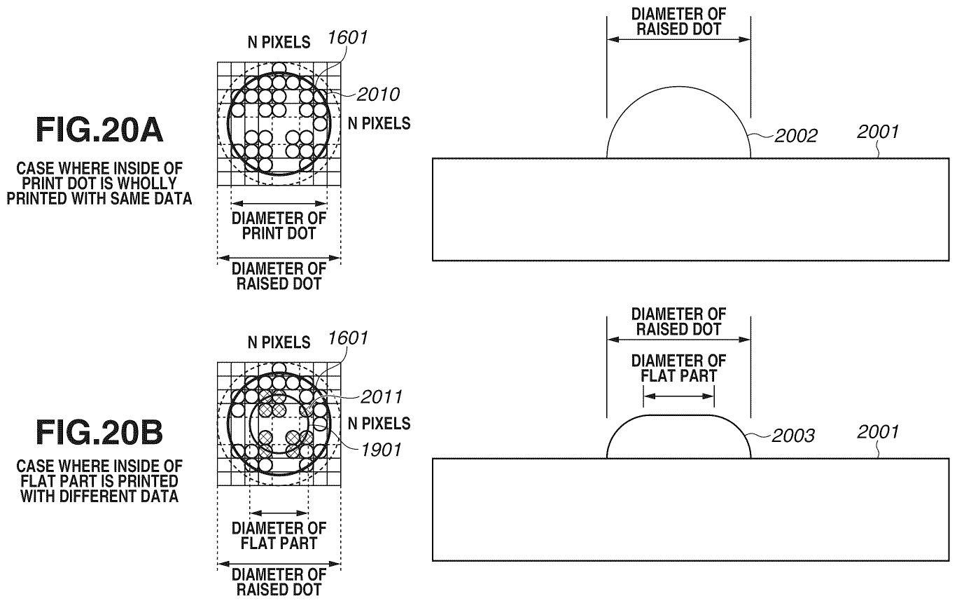

FIGS. 20A and 20B illustrate a method of forming a flat part on the apex of a raised dot.

FIG. 20A illustrates a state where the inside of the print dot 1601 is uniformly printed with ink dots 2010 as described in the second exemplary embodiment. As illustrated on the right in FIG. 20A, a raised dot 2002 formed on a recording medium 2001 has a dome shape in a cross-sectional view.

FIG. 20B illustrates a state where the inside of the flat part 1901 is not entirely printed, but is printed with thinned ink dots (reticulated ink dots 2011) in order to form the flat part on the apex of the raised dot. This makes it possible to reduce the amount of foaming promotion ink applied inside the flat part 1901. As illustrated on the right side in FIG. 20B, a raised dot 2003 formed on the recording medium 2001 has a shape with a reduced swelling apex of the convex portion.

In FIGS. 20A and 20B, an illustrated size ratio of the ink dot to the diameter of the raised dot is greater than the actual size ratio for description. Further, the ink dots are partially omitted.

In the present exemplary embodiment, processing is performed similarly to that in the flowchart illustrated in FIG. 13. In the following, differences from the second exemplary embodiment will be described.

In step S1305, the control unit 201 generates raised-dot image data from information about the diameter of the print dot calculated by the correction processing performed on the value of the diameter of the raised dot in the selected standard of the characters for visually impaired persons and the print resolution. At this time, the control unit 201 does not uniformly fill the inside of the print dot with the ink dots, but thins the ink dots inside the flat part.

According to the above-described present exemplary embodiment, when characters for visually impaired persons are printed by an image forming apparatus performing two-dimensional image printing, a part of the apex of each raised dot is made flat. This makes it possible to facilitate identification of the characters for visually impaired persons.

In the above-described exemplary embodiments, a three-dimensional image is printed using foaming promotion ink. However, ultraviolet curable ink (UV ink) or another type of ink can be used as long as the ink can form a three-dimensional shape on a recording medium. In the case of UV ink, UV ink can be used as long as the recording medium is made with a print base material to which the UV ink can be fixed, such as a polyethylene terephthalate (PET) film and a polypropylene (PP) film.

In the above-described exemplary embodiments, the formation of three-dimensional shape is controlled using print data indicating the amount of ink applied. However, the height of a three-dimensional shape can be controlled using print data for controlling the heating to a recording medium with ink applied thereto.

According to the exemplary embodiments, the control of three-dimensional shapes can be performed in a high convenient manner in forming three-dimensional shapes on recording media.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-206405, which was filed on Dec. 6, 2023 and which is hereby incorporated by reference herein in its entirety.

What is claimed is:

1. An apparatus, comprising:
at least one processor; and
at least one memory that is in communication with the at least one processor, wherein the at least one memory stores instructions for causing the at least one processor and the at least one memory to:
acquire first information indicating a type of a recording medium, and second information indicating a predetermined standard relating to a three-dimensional shape to be formed on the recording medium; and
generate print data for forming the three-dimensional shape based on the first information and the second information.

2. The apparatus according to claim 1, wherein the at least one memory further stores instructions for causing the at least one processor and the at least one memory to generate data, as the print data, indicating an amount of ink to be applied for forming the three-dimensional shape.

3. The apparatus according to claim 2,
wherein the ink for forming the three-dimensional shape is foaming promotion ink, and
wherein the recording medium includes a foaming layer.

4. The apparatus according to claim 2, wherein the ink for forming the three-dimensional shape is ultraviolet curable ink.

5. The apparatus according to claim 1, wherein the predetermined standard is a standard of characters for visually impaired persons.

6. The apparatus according to claim 5, wherein the standard of characters for visually impaired persons indicates a height of a raised dot.

7. The apparatus according to claim 6, wherein the at least one memory further stores instructions for causing the at least one processor and the at least one memory to generate the print data based on a relationship between an amount of ink applied and a height of a formed three-dimensional shape on the recording medium, and the height of the raised dot.

8. The apparatus according to claim 7, wherein the at least one memory further stores instructions for causing the at least one processor and the at least one memory to generate the print data with a lookup table indicating the relationship between the amount of ink applied and the height of the formed three-dimensional shape by the recording medium.

9. The apparatus according to claim 7,
wherein the standard of characters for visually impaired persons indicates a diameter of the raised dot, and
wherein the at least one memory further stores instructions for causing the at least one processor and the at least one memory to:
correct the diameter of the raised dot based on the recording medium; and
generate raised-dot image data based on the corrected diameter of the raised dot and print resolution.

10. The apparatus according to claim 9, wherein the at least one memory further stores instructions for causing the at least one processor and the at least one memory to thin ink dots printed in a predetermined region at a center of the raised dot having the corrected diameter.

11. The apparatus according to claim 1, wherein the at least one memory further stores instructions for causing the at least one processor and the at least one memory to acquire the second information indicating the predetermined standard selected by a user.

12. The apparatus according to claim 1, further comprising a printing unit configured to print the three-dimensional shape using an inkjet method.

13. The apparatus according to claim 1, wherein the at least one memory further stores instructions for causing the at least one processor and the at least one memory to generate data, as the print data, for controlling heating to the recording medium to which ink is applied.

14. A printing apparatus, comprising:
at least one processor; and
at least one memory that is in communication with the at least one processor, wherein the at least one memory stores instructions for causing the at least one processor and the at least one memory to:
receive, from a user, designation of a type of a recording medium and a predetermined standard relating to a three-dimensional shape to be formed on the recording medium; and
form the three-dimensional shape on the recording medium based on the type of the recording medium and the predetermined standard.

15. A method, comprising:
acquiring first information indicating a type of a recording medium, and second information indicating a predetermined standard relating to a three-dimensional shape to be formed on the recording medium; and
generating print data for forming the three-dimensional shape based on the first information and the second information.

16. A non-transitory computer-readable storage medium storing instructions that, when executed by a computer, cause the computer to perform a method, the method comprising:
acquiring first information indicating a type of a recording medium, and second information indicating a predetermined standard relating to a three-dimensional shape to be formed on the recording medium; and
generating print data for forming the three-dimensional shape based on the first information and the second information.
